(19) United States
(12) Patent Application Publication
(10) Pub. No.: US 2009/0135201 A1
(43) Pub. Date: May 28, 2009

(54) DEVICE AND METHOD FOR ADAPTING MEDICAL IMAGES FOR REPRESENTATION ON A LARGE DISPLAY

(76) Inventor: Bernd Keuenhof, Kleinsendelbach (DE)

Correspondence Address: BRINKS HOFER GILSON & LIONE, P.O. BOX 10395, CHICAGO, IL, 60610, US

(21) Appl. No.: 12/272,392

(22) Filed: Nov. 17, 2008

(30) Foreign Application Priority Data
Nov. 23, 2007 (DE) 10 2007 056 431.9

(51) Int. Cl. G09G 5/00

(52) U.S. Cl. 345/629

(57) ABSTRACT

The present embodiments relate to an adaptation device and a method for representing a plurality of images on a large display. The adaptation device has a plurality of inputs for different types of medical image and is embodied for compiling an overall image from at least two different types of image in accordance with control information. In addition an output is provided for transmission of the overall image to the large display for the purposes of representation. The representation is adapted by the adaptation device for display on the large display in accordance with the control information. An advantage of the present embodiments may be that the representation of medical images on a large display can be adapted for a better visual impression.

This patent document claims the benefit of German Patent Application No. DE 10 2007 056 431.9 filed on Nov. 23, 2007, which is hereby incorporated by reference.

### BACKGROUND

The present embodiments relate to representing a plurality of images on a large display.

During medical examinations in a hospital, a plurality of representations or images may be used to provide the best possible record of the part of the body being examined. For example, a number of different perspectives can be shown by a medical imaging method. Different imaging methods or modalities (e.g. x-ray, computer tomography, ultrasound, magnetic resonance tomography, video, scattering of laser beams) are combined in order to obtain as much information as possible about conditions adversely affecting the health of the patient. A number of displayed images are also employed, if under different conditions (e.g. before and after inclusion of contrast media) recorded images are overlaid in order to obtain an image with as high a contrast as possible (difference method).

Different medical images are each generally displayed on individual, dedicated reproduction devices. Accordingly, a separate image reproduction device is needed for each video (e.g., graphics card) output of a medical imaging system. In modern x-ray examination units, eight or even more image reproduction devices are needed in the examination room including color displays for electrocardiogram (EKG) and ultrasound.

A solution with many displays is unmanageable, inflexible and difficult to scale up. “New Display Solutions for the Image-Centric Era of Healthcare” by S. Bonfiglio and L. Albani in SID Symposium Digest of Technical Papers—May 2007—volume 38, Issue 1, pp. 123-126 disclose that a plurality of medical images are shown on a large display in order to make do with one display per examination station. The publication describes an input device by which images to be shown on a large display can be selected from a plurality of possible medical images. The input device (e.g., a tablet PC) has a display that includes a first area with selectable images and a second area in which the images represented on the large display are shown. Moving an image from the first area into the second area selects this image and causes it to be displayed on the large display.

### SUMMARY AND DESCRIPTION

The present embodiments may obviate one or more of the problems or drawbacks inherent in the related art. For example, in one embodiment, the representation of combinations of medical images on a large display may be optimized.

In another example, the representation of a plurality of medical images on a large display may be improved.

In one embodiment, various types of medical images are merged for a common representation on a large display by an adaptation device and adapted in accordance with control information.

Various types of medical image may include different medical modalities, different recording perspectives, or different image processing procedures (e.g. difference images, removal of artifacts, native unprocessed images . . . ).

An overall image may be created or composed. The overall image may include individual images and information to be shown on the large display. As used herein, the representation of an image may include the representation of sequences of images or streams of similar images, which are displayed one after the other on the large display. Accordingly, streams of images currently being recorded, for example, may be transferred from an imaging device or a modality to the adaptation device.

The overall image is transmitted to a large display for the purposes of representation. A large display or large screen may be an image reproduction device, a display, a monitor, or a screen. The large display or large screen may have technical characteristics (e.g., resolution, luminance and dimensions) that allow for the simultaneous display of at least two images or streams of images of a sufficient size and quality for diagnostic or therapeutic applications in the hospital. Monitors that have a resolution from 4 M pixels to over 8 M pixels and a screen size from 30″ to 64″ are suitable for application as a large display in a hospital.

Different elements for display (e.g., images, information) may be adapted for better (e.g. more clear or more uniform) representation. Different types of images are adapted for the purposes of unifying the representation of the images of the overall image. The adaptation relates, for example, to image parameters such as image reproduction curve, brightness, and contrast or the color coordinates of the individual images. Independent adaptation of the images may be possible for each input of the adaptation device via which images will be received. In one embodiment, the images displayed on the large display will be adapted so that they may be easily distinguished from each other. For example, color, format, shape, or thickness of an image frame displayed may be used to distinguish the images. Alternatively, or additionally, the image source (e.g. Live A) may be included or identified. The images are standardized or adapted to each other to allow easy comparison, but for the purposes of distinction are clearly distinguished from each other (e.g., using a colored frame, label, etc.).

The control information may, for example, include an image configuration. An image configuration may include the selection and arrangement of elements (e.g., images and information) for representation on the large display. An image configuration may include a number of images. The image configuration is, for example, able to be determined using an input device, for example, by direct selection or via a called program that controls the representation and provides control information for the adaptation device.

In one embodiment, when an image is no longer transferred to the adaptation device after an outage, the image may be replaced by an emergency image. The adaptation device in this development is equipped to detect automatically that an image to be displayed is no longer present and to replace the image by an emergency image. A message may be included on the large display. The message may give information about the switchover to emergency operation or the emergency image. A return to normal operation may be automatically detected and the emergency image may be replaced by the adaptation device with the regular image.

### BRIEF DESCRIPTION OF THE DRAWINGS

FIG. 1 illustrates one embodiment of a medical display system; and

FIG. 2 illustrates one embodiment of an image configuration.

### DETAILED DESCRIPTION

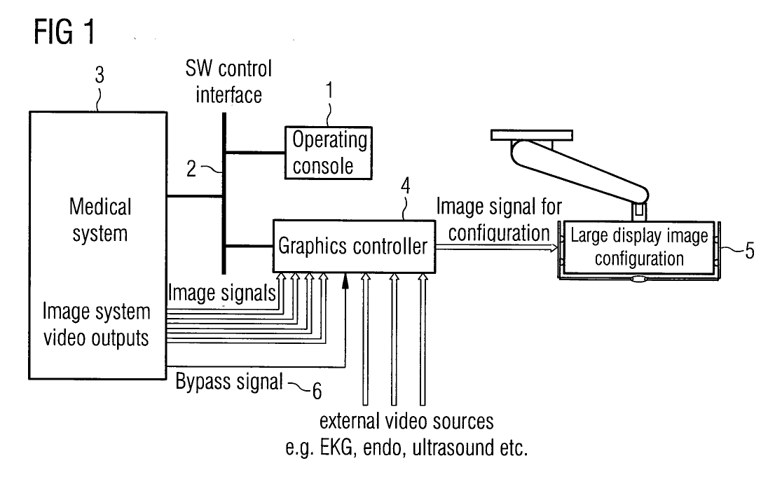

FIG. 1 shows a system for representation of image configurations on a large display 5. Image configurations can be selected for display on a large display 5 via an operator console 1, which is connected via a software control interface 2 to a medical system 3 and a graphics controller 4. The operator console 1 is also used for operation or control of the medical system 3. The medical system 3 may be an x-ray angiography system, for example, with which angiography images are created. These images are transferred to the graphics controller 4. A number of inputs may be provided to enable a plurality of images for display (e.g. reference images and difference images) to be transferred separately from the angiography system to the graphics controller 4.

A workflow may be selected via the input device, for example, the operator console 1. For example, organs or parts of the body may be selected via the input device, which starts an associated program (e.g. organ program). A workflow corresponds to the program or the examination or treatment of the organ or part of the body. The representation on the large display 5 may then be controlled by the program to support the workflow. An image configuration suitable for the workflow may be defined for representation on the large display 5. The image configuration is transmitted to the graphics controller 4. The graphics controller 4 includes further inputs to external video sources, for example, EKG, endoscopy, or ultrasound. The external video sources may be referenced by the image configuration, i.e. selected for representation on the large display 5. The graphics controller 4 may be an adaptation device that compiles an image in accordance with the selected image configuration and if necessary other control information and transmits a corresponding image signal to the large display 5.

Additional control information may be specified by the user by making an entry at the operator console 1. Another option is the automatic generation of control information for the compilation of the image by the graphics controller 4 by the program, which is also responsible for adapting the image configuration represented on the large display in accordance with the workflow or the sequence of the treatment or examination.

The medical system 3 may send a bypass signal 6 or emergency signal to the graphics controller 4. If the medical system 3 is rebooted, for example, the bypass image signal is sent to the graphics controller 4. The graphic controller 4 may scan the bypass image signal at the graphic controller's 4 image signal input. Accordingly, the graphic controller 4 switches automatically to a bypass configuration or emergency configuration previously defined in the system. A notification message is shown on the large display without the doctor, who is handling the treatment, having to perform a manual operation. If, after the reboot of the medical system 3, an image signal is present, the graphic controller 4 automatically switches back to a predefined default configuration.

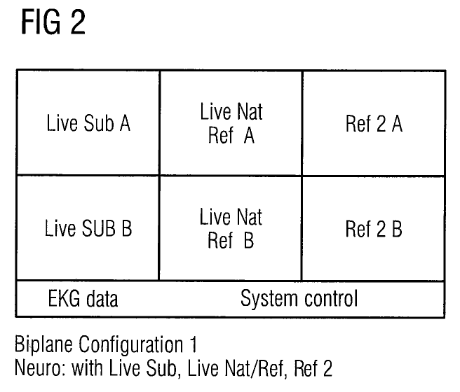

FIG. 2 shows an image configuration that can be used for representation by the system from FIG. 1. The image configuration includes six images: Live Sub A, Live Sub B, Live Nat Ref A, Live Nat Ref B, Ref 2 A, and Ref 2 B. The six images may be represented on the large display. Live Sub A and Live Sub B are subtraction images. Live Nat Ref A and Live Nat Ref B are native unprocessed images. Ref 2 A and Ref 2 B are reference images.

The image compilation may be, for example, used for an angiography examination. Vessels are examined using x-ray images in angiography. For this purpose a radioactive contrast is introduced into the vessels and an x-ray image is recorded. A contrast may be obtained when, by an x-ray image recorded before application of the contrast media, the background of the image is removed so that only the vessels can still be seen (e.g., a difference image). An image must thus be recorded before adding the contrast media (e.g., Ref 2 A and Ref 2 B) which is overlaid with the image after addition of the contrast media (e.g., Live Nat Ref A and Live Nat Ref B) for removing the background, in order to generate a difference image (e.g., Live Sub A and Live Sub B) in which essentially only the vessels are still shown.

A bar may be shown in the image configuration on the lower edge of the large display. EKG data and information for system control may be shown in the bar.

While the invention has been described above by reference to various embodiments, it should be understood that many changes and modifications can be made without departing from the scope of the invention. For example, although the embodiments were discussed in conjunction with a particle therapy system, the same problems and solutions arise in photon therapy as well. It is therefore intended that the foregoing detailed description be regarded as illustrative rather than limiting, and that it be understood that it is the following claims, including all equivalents, that are intended to define the spirit and scope of this invention.

1. An adaptation device for representation of a plurality of images on a large display, the adaptation device comprising:
a plurality of inputs for different types of medical images; and
an output for transmission of an overall image to a large display for representation of the overall image,
wherein the overall image is compiled from at least two different types of images in accordance with control information.

2. The adaptation device as claimed in claim 1, wherein at least one of the at least two different types of image is adapted to unify the representation of the images of the overall image.

3. The adaptation device as claimed in claim 1, wherein the overall image includes information for display on the large display.

4. The adaptation device as claimed in claim 1, wherein the control information comprises an image configuration in accordance with which the overall image is able to be compiled.

5. The adaptation device as claimed in claim 4, wherein an input device defines the image configuration.

6. The adaptation device as claimed claim 1, wherein the control information is used to label the images displayed on the large display.

7. The adaptation device as claimed in claim 1, wherein at least one input of the adaptation device is operable to transmit an emergency image assigned to a regular image, and wherein the adaptation device is operable to detect whether the regular image is present at the at least one input and to use the emergency image instead of the regular image if no regular image is present.

8. A method for representing a plurality of images on a large display, the method comprising:
transmitting a plurality of different types of medical images to an adaptation device,
compiling an overall image from at least two of the plurality of different types of images in accordance with control information by the adaptation device, and
transmitting the overall image to a large display for representation of the overall image.

9. The method as claimed in claim 8, further comprising adapting at least one of the at least two of the plurality of different types of images for unifying the representation of the images of the overall image.

10. The method as claimed in claim 8, further comprising compiling the overall image from both images and information that is to be displayed on the large display.

11. The method as claimed in claim 8, wherein the control information comprises an image configuration in accordance with which the overall image is compiled.

12. The method as claimed in claim 11, further comprising transferring the image configuration to the adaptation device from an input device that is operable to be used to define the image configuration.

13. The method as claimed in claim 8, further comprising identifying an image represented on the large display in accordance with the control information.

14. The method as claimed in claim 8, further comprising: assigning an emergency image a regular image that is transferred to at least one input of the adaptation device,
detecting whether the regular image is present at the at least one input provided for the regular image, and
representing the emergency image instead of the regular image on the large display when the regular image is not present at the at least one input.

15. A computer program that may be executed to:
transmit a plurality of different types of medical images to an adaptation device,
compile an overall image from at least two of the plurality of different types of images in accordance with control information by the adaptation device, and
transmit the overall image to a large display for representation of the overall image.
